(19) United States
(12) Patent Application Publication
(10) Pub. No.: US 2006/0158677 A1
(43) Pub. Date: Jul. 20, 2006

(54) Enhanced image data processing method and apparatus

(76) Inventors: Atousa Soroushi, North Vancouver (CA); George Lyons, Langley (CA); Barinder Singh Rai, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/037,843

(22) Filed: Jan. 18, 2005

(51) Int. Cl. G06F 3/12

(52) U.S. Cl. 358/1.15

(57) ABSTRACT

Provided is a method and apparatus for generating a single header from a stream of image data. A first frame of image data of the stream of image data is received by a graphics controller, which generates the header. The header is then stored in buffers of a memory of the graphics controller. Subsequently, encoded image data of the first frame of image data and subsequent frames of image data are stored at an offset from the header within the buffers. Thereafter, when a processor decodes the encoded image data, the processor retrieves the contents of the buffer having the header of the first frame of image data and encoded image data.

### BACKGROUND

1. Field of the Invention

The present invention relates to image processing, and more specifically to enhancing image data processing by reducing the amount of header information generated for a stream of image data.

2. Description of the Related Art

Image data processing includes receiving image data and generating header information related to the image data. For example, the header information can include information regarding compression of the image data.

If a camera captures image data by frames, then an image data processing engine may encode one frame of image data and generate header information for the frame after the image data capture. However, if the image data processing engine does not encode the frame of image data fast enough, then this may cause a downstream delay with a processor in communication with the image data processing engine. For example, the processor can only decode the image data as fast as the image processing engine can encode the image data. On a desktop computer, such delays may be negligible because the desktop computer typically has one or more image processing engines and large memories that can buffer mass quantities of image data. However, in some devices, the delays are not negligible. Specifically, constraints such as small memories and limited battery power require minimal delays during the operation of some devices, such as mobile handheld devices. Additionally, devices without these constraints may have downstream processing delays because of the current encoding ratio.

Accordingly, what is needed is a method and apparatus for enhancing image data processing in devices having limited computing resources to improve processing times during image data encoding and decoding.

### SUMMARY

Broadly speaking, the present invention is a method and apparatus for enhanced image data processing to improve an encoding ratio of a stream of image data. It should be appreciated that the present invention can be implemented in numerous ways, such as a process, an apparatus, or a device, of which several inventive embodiments of the present invention are described below.

An embodiment of a method of processing image data includes generating header information of a first frame of image data. The header information is stored in a first buffer at a first location and a second buffer at a corresponding second location. The method also includes encoding the frame of image data for storage in the first buffer at a third location as compressed image data. Further, the method includes transmitting the stored header information and the compressed image data for decoding from the first buffer, such that subsequent compressed image data without generating header information is stored in the first buffer at the third location or the second buffer at a corresponding fourth location. The transmitting includes the stored header information and the subsequent compressed image data.

In an embodiment of a method of encoding image data, the method includes receiving a first frame of image data and generating header information of the first frame of image data. The method also includes storing both the first frame of image data as encoded image data and the header information in a first buffer. Further, the method includes disabling the generation of header information, thereby storing subsequent frames of image data without generating header information.

In an embodiment of a graphics controller for processing image data, the graphics controller includes an image data encoder configured to receive and compress a first frame of image data. The graphics controller also includes a memory coupled to the image data encoder. The memory has a first buffer and a second buffer, such that generated header information of the first frame of image data is stored in a first portion of the first buffer and the second buffer. Further, the graphics controller includes an offset portion of the first buffer and the second buffer. The offset portion of the first buffer is adjacent to the first portion of the first buffer and the offset portion of the second buffer is adjacent to the first portion of the second buffer. The offset portion includes a compressed subsequent frame of image data without generated header information of a subsequent frame of image data.

In an embodiment of a computer program embodied on a computer readable medium for processing image data, the computer program includes instructions for generating header information of a first frame of image data. The header information is stored in a first buffer at a first location and a second buffer at a corresponding second location. Further, the computer program includes instructions for encoding the frame of image data for storage in the first buffer at a third location as compressed image data. Moreover, the computer program includes instructions for transmitting the stored header information and the compressed image data for decoding from the first buffer. Subsequent compressed image data without generating header information is stored in the first buffer at the third location or the second buffer at a corresponding fourth location. The transmitting includes the stored header information and the subsequent compressed image data.

In an embodiment of a method for enabling an electronic device to more efficiently process image data, the method initiates with establishing compression parameters to be applied to compress the image data. The method includes transmitting the compression parameters simultaneously to an image capture sensor and a graphics engine of the device and transferring a data unit of compressed image data from the image capture sensor to the graphics engine without including a header defining the compression parameters. The method also includes decoding the data unit through the compression parameters of the graphics engine.

In a method for efficiently processing captured image data through a device, the method initiates with compressing the captured image data. A header is applied to a first data unit of the compressed captured image data through logic associated with an image capture sensor. The first data unit of the compressed captured image data is transmitted to a graphics controller and subsequent data units of the compressed captured image data are transmitted to the graphics controller without any header information. Compression parameters are extracted from the header information of the first data unit and stored in memory associated with the graphics controller. The first data unit and the subsequent data units are decoded with the compression parameters.

In an image capture device, the device includes an image capture sensor capable of compressing captured image data. A graphics controller configured to program the image capture sensor with compression parameters upon initialization of the device is included. The graphics controller is further configured to load the compression parameters into a decode module of the graphics controller, thereby enabling the image capture sensor to transmit the compressed captured image data without header information.

Other embodiments of the invention will become apparent from the following detailed description, taken in conjunction with the accompanying drawings, illustrating by way of example the principles of the invention.

### BRIEF DESCRIPTION OF THE DRAWINGS

Exemplary embodiments of the invention may be understood by reference to the following description, taken in conjunction with the accompanying drawings in which:

FIG. 1 is a timing diagram illustrating generating one header and encoding image data, in accordance with an embodiment of the invention;

FIG. 2 is a diagram illustrating a device for processing image data, in accordance with an embodiment of the invention;

FIG. 3 is a diagram illustrating a memory having two buffers, in accordance with an embodiment of the invention;

FIG. 4 is a diagram illustrating a memory having two buffers storing image data without header information, in accordance with an embodiment of the invention;

FIG. 5A is a diagram illustrating a memory having two buffers, in accordance with another embodiment of the invention;

FIG. 5B is a diagram illustrating a memory having two buffers having offsets, in accordance with another embodiment of the invention;

FIG. 6 is a flowchart diagram of a method of processing image data, in accordance with an embodiment of the invention;

FIG. 7 is a flowchart diagram of another method of processing image data, in accordance with an embodiment of the invention;

FIG. 8 is a flowchart diagram of a method of processing image data in a buffer having an offset, in accordance with another embodiment of the invention; and

FIG. 9 is a flowchart diagram of another method of processing image data in a buffer having an offset, in accordance with another embodiment of the invention.

FIG. 10 is a simplified schematic diagram illustrating a portable electronic device in which an image capture sensor configured to transfer the image data to a graphics controller for decoding in accordance with one embodiment of the invention.

FIG. 11 is a flow chart diagram illustrating the method operations for enabling an electronic device to more efficiently process image data in accordance with one embodiment of the invention.

### DETAILED DESCRIPTION

The following embodiments describe a method and apparatus for enhanced image data processing. For example, mobile devices with limited resources such as battery powered devices having relatively small memories can reduce power consumption and processing delays by reducing the encoding ratio of image data through the embodiments described below. The embodiments described herein generate a single header and subsequently process multiple frames of image data without generating additional header information. Thus, by reducing the generated header information, exemplary embodiments can improve the encoding ratio for image data processing. Although the embodiments described herein are described in relation to mobile devices, other embodiments can include any device for performing enhanced data image processing. It will be obvious, however, to one skilled in the art, that the present invention may be practiced without some or all of these specific details. In other instances, well known process operations have not been described in detail in order not to unnecessarily obscure the present invention.

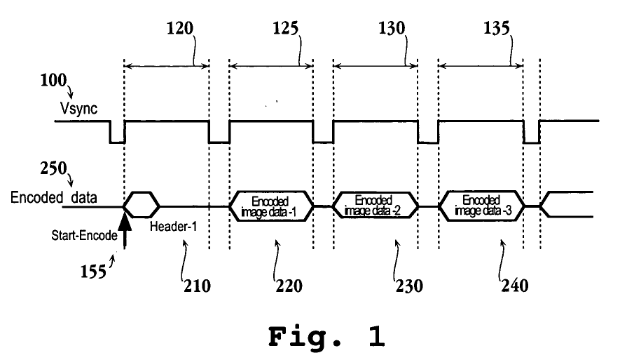

FIG. 1 illustrates a timing diagram for generating one header and encoding image data, in accordance with an embodiment of the invention. An exemplary embodiment of enhanced image data processing includes processing a stream of continuous camera image data 250 during a camera vertical synchronization (VSYNC) 100. At time-A 120, a header-1 210 is generated at start encode 155. The header-1 210 includes information regarding the image data to be encoded. For example, the information can include the size of a frame of image data. At time-B 125, a first frame of image data is processed to generate an encoded image data-1 220 corresponding to the header-1 210. Then, at time-C 130, a second frame of image data is processed to generate an encoded image data-2 230 corresponding to the header-1 210. At time-D 135, a third frame of image data is processed to generate an encoded image data-3 240 corresponding to the header-1 210. Thereafter, during one VSYNC 100 clock cycle, each frame of image data is encoded corresponding to the header-1 210. In other embodiments, other methods to provide image data for enhanced image data processing are possible, as long as only one header information is generated at the beginning of a stream of image data. Thus, an encoding ratio closer to 1:1 is realized.

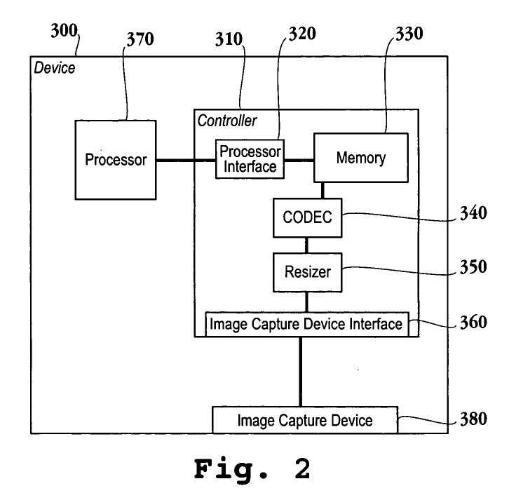

It should be appreciated that the compressed image data can have many suitable formats after encoding. Exemplary formats include joint photographic experts group (JPEG), graphics interchange format (GIF), portable network graphics (PNG), tagged image file format (TIFF), and bit-mapped graphics (BMP), etc. In accordance with an exemplary embodiment, FIG. 2 illustrates a device 300 for processing image data having any suitable format. The device 300 can be a mobile device such as a cell phone, digital camera, a cell phone with a digital camera, a personal digital assistant (PDA), or other mobile devices having graphics processing capability. Accordingly, the device 300 can also be a copier, a facsimile machine, a general-purpose computer, or a computer used for a specific purpose, etc.

The device 300 includes a controller 310, a processor 370, and an image capture device 380. In other exemplary embodiments, the image capture device 380 may be external to the device 300. Exemplary image capture devices include a charged coupled device and a complementary metal oxide semiconductor sensor. The controller 310, the processor 370, and the image capture device 380 are coupled together to propagate image data from the image capture device 380 to the controller 310. However, the connections illustrated in FIG. 2 are exemplary and other connections are possible, as long as image data propagates through the device 300.

In yet another embodiment, the device 300 may not receive image data from the image capture device 380. For example, the device 300 may receive image data from a wireless connection to another device. Thus, one of ordinary skill in the art will recognize that the device can receive image data from any source as long as the device 300 is capable of achieving an encoding ratio of approximately 1:1.

Image data is processed by and stored in the memory 330 of the controller 310. Thereafter, the processor 370 decodes image data stored in the controller 310 by retrieving the encoded image data from the memory 330. To decode the stored image data, the processor 370 uses the header information, such as the header-1 210 (FIG. 1) generated during the processing of the stream of continuous camera image data. Within the controller 310 are a processor interface 320, a memory 330, a codec 340, a resizer 350, and an image capture device interface 360. The processor interface 320 interfaces the processor 370 with the memory 330, which stores the encoded image data. Thus, when the processor 370 retrieves the encoded image data stored in the memory 330, the processor interface 320 arbitrates access to the memory 330.

The memory 330 receives encoded image data generated by the codec 340. In one embodiment, the codec 340 is a coder/decoder including circuitry and logic capable of generating the header information of the frame of image data and encoding the frame of image data. In another embodiment, the codec 340 can also be a compression/decompression engine configured to compress and decompress a frame of image data. In yet other embodiments, the encoder/decoder includes the capability to produce a compressed frame of image data. Thus, in one exemplary embodiment, the codec 340 encodes frames of image data as JPEG. However, the codec 340 can produce any graphics format of encoded image data for storage in the memory 330. In other exemplary embodiments, the codec 340 can be an encoder without decoding capability, as long as the codec 340 generates the header information and encodes frames of image data.

The resizer 350 coupled to the codec 340 crops and scales image data. Thus, the resizer 350 provides frames of image data to the codec 340. The frame of image data is an array of pixels wherein the pixels can represent any color scheme. An exemplary color scheme is RGB888, which uses 8 bits to represent each color value of the pixel. In other exemplary embodiments, other color schemes are possible, as long as the pixels can be organized as frames of image data. The image capture device interface 360, coupled to the resizer 350, is capable of managing the stream of image data from the image capture device 380. As mentioned above, the image capture interface 360 can receive the stream of image data from any suitable source.

The stream of image data includes frames of image data that can be stored in the memory 330. The memory includes buffers, wherein the buffers have identifiable locations organized by memory addresses. The memory addresses identify starting and ending addresses of locations that can store the frames of image data. Thus, in an exemplary embodiment, when the codec 340 generates the header-1 210 (FIG. 1) during time-A 120 for a first frame of image data, the header-1 210 is stored in the memory 330 at an identifiable memory address. After the generation of the header-1 210, the codec 340 ceases to generate further header information for subsequent frames of image data.

In an exemplary embodiment, the codec 340 ceases to generate further header information because a signal (not shown) to the codec 340 has been disabled. For example, the signal can indicate whether or not the codec 340 should generate header information. When enabled, the signal can indicate that the codec 340 should generate header information. When disabled, the lack of the signal indicates that the codec 340 should not generate header information. One of ordinary skill in the art will recognize that an alternative embodiment can include an enable signal that indicates that the header information should not be generated. Consequently, a disable signal indicates that the header should be generated. Thus, any suitable method of signaling to the codec 340 to cease generating header information is possible.

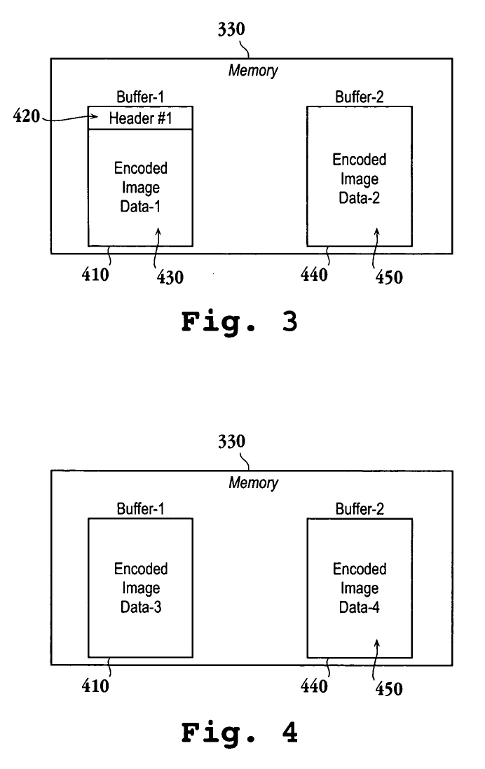

FIG. 3 is a diagram illustrating the memory 330 having two buffers, in accordance with an embodiment of the invention. The memory 330 includes a buffer-1 410 and a buffer-2 440. It should be appreciated that in other embodiments, the memory 330 can include any suitable number of buffers. The header-1 210 of FIG. 1 can be stored in the buffer-1 410 at a first location 420 of FIG. 3. Then, the encoded image data-1 220 of FIG. 1 is stored in the buffer-1 410 at a second location 430 of FIG. 3. It should be appreciated that the first location 420 and the second location 430 are identified by memory addresses. Thereafter, because the capability of the codec 340 to generate header information is disabled, the codec 340 encodes subsequent frames of image data without generating header information for the encoded image data. Thus, for a second frame of image data, the encoded image data-2 230 is stored in the buffer-2 440 at a location 450.

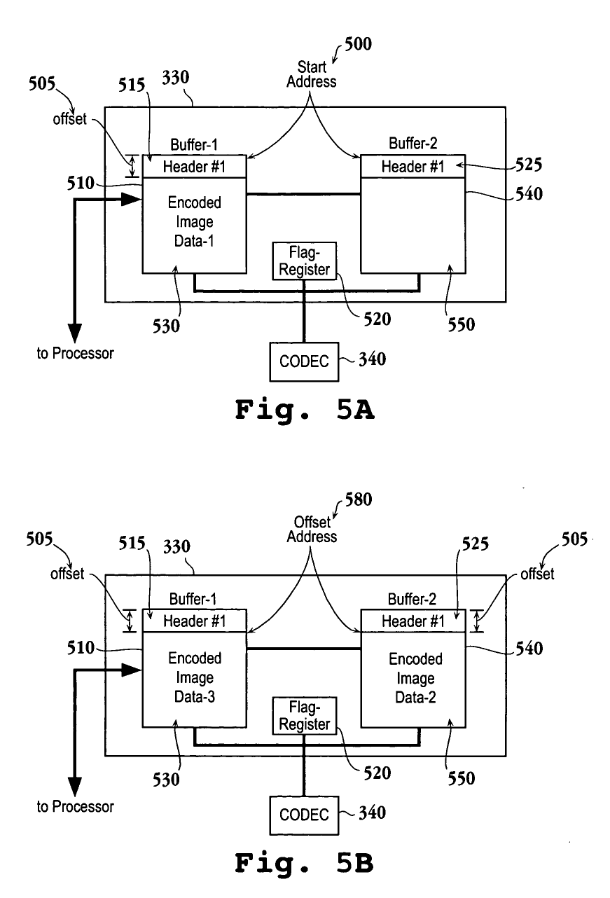

As soon as the header and the encoded image data are stored in the buffer-1 410, the processor 370 of FIG. 2 can retrieve the contents of the buffer-1 410 for decoding. Thus, the controller 310 of FIG. 2 includes logic capable of transmitting the generated header information and the encoded image data, which is the compressed first frame of image data. The generated header information, such as the header-1 210 of FIG. 1 that is stored by the processor, may be reused by the processor for decoding encoded image data in order to eliminate corresponding header information for subsequently decoded image data. For example, a third frame of image data and subsequent frames of image data encoded by the codec will not have corresponding header information. Thus, FIG. 4 is a diagram illustrating the memory 330 having two buffers storing image data without header information, in accordance with an embodiment of the invention. Specifically, after the transmission of the encoded image data-1, the buffer-1 410 can store the encoded image data-3 in a combined location. The combined location includes the first location 420 and the second location 430 of FIG. 3. Correspondingly, when the processor 370 of FIG. 2 retrieves the encoded image data-2 from the buffer-2 440, the location 450 is available to store an encoded image data-4 in location 450.

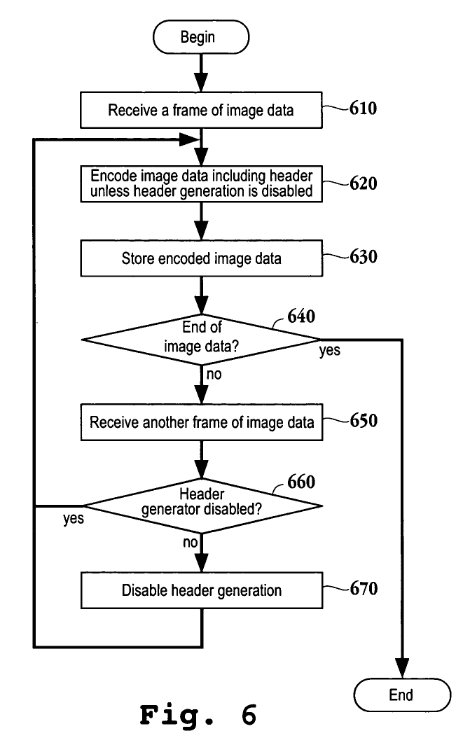

In another exemplary embodiment, where only one header is generated for the stream of encoded data, both the header information and the encoded image data are stored in the buffers. FIG. 5A is a diagram illustrating a memory having two buffers, in accordance with another embodiment of the invention. In addition to a buffer-1 510 and a buffer-2 540, the memory 330 includes a flag-register 520. The codec 340 is in communication with the flag-register 520. The flag-register 520 is in communication with both buffers. Both buffers may also be directly connected. It should be appreciated that the connections illustrated in FIG. 5A are purely exemplary, and any configuration is possible, as long as there exists a communication pathway between the buffers and the codec 340.

Still referring to FIG. 5A, the flag-register 520 includes access logic capable of indicating that encoded image data is stored in a buffer. Thus, when the processor 370 of FIG. 2 retrieves the contents of a buffer, the flag-register 520 is capable of identifying the buffer with encoded image data. When a first frame of image data arrives at the codec 340, the codec generates the header #1. The header #1 is stored in the buffer-1 510 at a first location 515, beginning at a start address 500. Correspondingly, the header #1 is also stored in the buffer-2 540 at a corresponding second location 525, beginning at the start address 500.

The codec 340 then generates the encoded image data-1, which is stored in the buffer-1 510 at a third location 530 in FIG. 5A. The starting address of the third location 530 is an offset 505 from the start address 500 equivalent to the header information size. After storage of the encoded image data-1, the flag-register 520 indicates that the contents of the buffer-1 510 are available for retrieval.

To permit the retrieval of the data, transmission logic of the codec 340 is capable of transmitting the header information and encoded image data to the processor 370 of FIG. 2. When the processor retrieves the contents of the buffer-1 510, the processor may decode the encoded image data without storing the header information because the header #1 is stored in the first location 515. Correspondingly, when the processor retrieves the contents of the buffer-2 540, the processor can again decode the encoded image data without storing the header information because the header #1 is stored in the second location 525.

For subsequent frames of image data, the codec 340 avoids generating header information. Thus, when a second frame of image data arrives at the codec 340, the encoded image data-2 is stored in an available buffer. An example of storing subsequent frames of encoded image data is illustrated in FIG. 5B, which is a diagram illustrating a memory having two buffers having offsets, in accordance with another embodiment of the invention. Specifically, the encoded image data-2 is stored in a fourth location 550 of the buffer-2 540. The flag-register 520 then indicates that the contents of the buffer-2 540 are available for retrieval. During the retrieval, a third frame of image data is encoded and stored in the now available third location 530 at an offset address 580. Accordingly, encoded image data can be stored in the third location 530 or the fourth location 550 at corresponding locations having starting memory addresses identified by the offset address 580. It should be appreciated that subsequent data may be stored in a similar fashion upon retrieval of the data currently stored within the buffers.

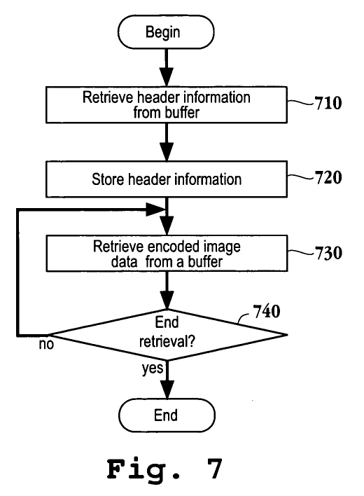

FIG. 6 is a flowchart diagram of a method of processing image data, in accordance with an embodiment of the invention. Although the following operations are described and illustrated in a particular order, the operations should not be restricted to that particular order. For example, the operations can be performed individually or in parallel, such as operations performed in a parallel computing system. Further, instructions of a computer program embodied on a computer readable medium for executing the operations are possible.

Specifically, the method of FIG. 6 begins when the graphics controller receives a frame of image data in operation 610. The graphics controller includes logic capable of storing generated header information and concatenating encoded image data to the header information. The combined header information and encoded image data are stored in a buffer of a memory of the graphics controller. Thus, in operation 620, logic of the graphics controller encodes the image data including the header information unless header generation is disabled. Then, in operation 630, the graphics controller stores the encoded image data in a buffer of the memory. In operation 640, if there are no further frames of image data to encode, then the method ends.

In operation 650, the graphics controller receives another frame of image data when there are additional frames of image data to encode. Then, in operation 660, if header generation is disabled, the method returns to operation 620. However, if header generation is not disabled, then in operation 670, header generation is disabled in an encoder of the graphics controller. Thus, subsequent frames of image data after a first frame of image data will not have header information generated.

FIG. 7 is a flowchart diagram of another method of processing image data, in accordance with an embodiment of the invention. After storing the encoded image data in the buffers of the graphics controller, a processor connected to the graphics controller can retrieve header information from the buffer in operation 710. The processor can store the header information in operation 720 in a register of the processor or some other storage location. The processor also retrieves the encoded image data from a buffer in operation 730. Thereafter, in operation 740, the processor determines whether to end retrieval of buffer contents. If retrieval does not end, then in operation 730, the processor retrieves the encoded image data of another buffer. By alternating between two buffers, the processor can continually retrieve encoded image data while the graphics controller continually encodes and stores frames of image data.

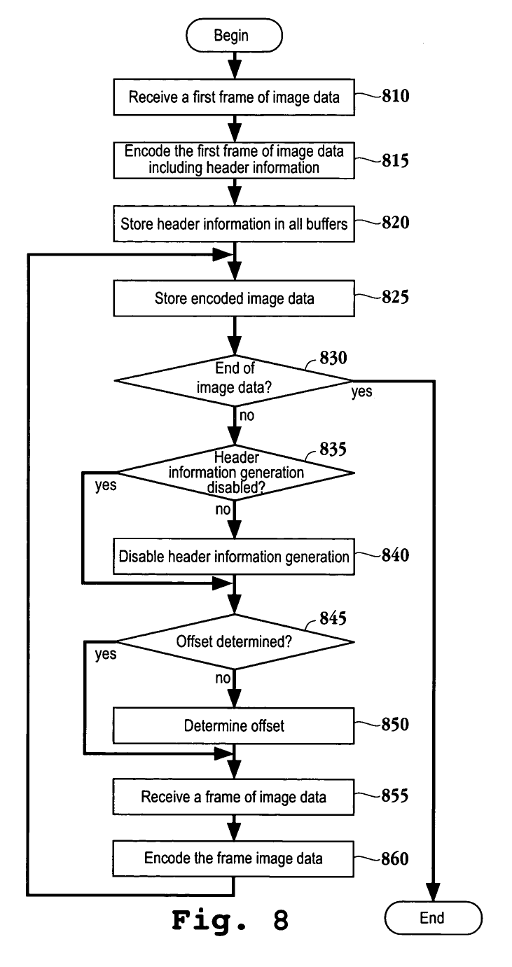

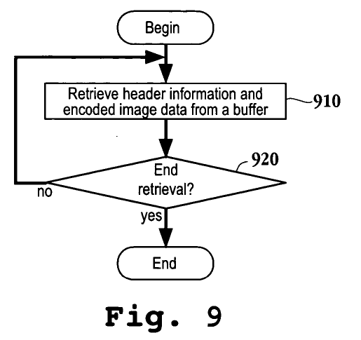

FIG. 8 is a flowchart diagram of a method of processing image data in a buffer having an offset, in accordance with another embodiment of the invention. In operation 810, a graphics controller receives a first frame of image data. Then, in operation 815, an encoder, such as the codec of the graphics controller of FIG. 2, encodes the first frame of image data including header information. Subsequently, in operation 820, the codec stores the header information in all buffers through logic contained therein. This logic is capable of duplicating the header information for storage and of identifying the start address of the buffers.

In operation 825, the graphics controller stores the encoded image data in a buffer. In one embodiment, to accomplish the storage of the encoded image data, the previously mentioned logic is capable of determining an offset address from a start address of the buffer. Consequently, the encoded image data is stored at an offset portion, such that the beginning of the offset portion is identified by the offset address, as illustrated with reference to FIGS. 5A and 5B.

If in operation 830, the graphics controller determines that there is no further image data, then the method ends. Alternatively, in operation 835, the graphics controller determines if header information generation is disabled for subsequent frames of image data. If header information generation is disabled, then the method proceeds to operation 845. Otherwise, in operation 840, the graphics controller disables header information within the encoder of the graphics controller. In operation 845, the graphics controller decides whether an offset is determined. In one embodiment, the offset is equivalent to the header information size generated from the first frame of image data. If the offset is not determined, then in operation 850, the graphics controller determines the offset in order to identify the beginning address of an offset portion used to store encoded image data. Thereafter, the method proceeds to operation 855. If the offset is determined in operation 845, then the method proceeds to operation 855, where the graphics controller receives a frame of image data. In operation 860, the encoder encodes the frame of image data and then stores the encoded image data in operation 825. The method then repeats as described above.

FIG. 9 is a flowchart diagram of another method of processing image data in a buffer having an offset, in accordance with another embodiment of the invention. Specifically, the graphics controller is capable of storing encoded image data in the offset portion of the buffers wherein the buffers already contain header information of the first frame of image data. Thus, when a processor retrieves the contents of the buffers, each buffer includes the header information of the first frame of image data and encoded image data. Accordingly, during decoding, the processor does not have to store the header information, as described in FIG. 7.

In operation 910, the processor retrieves the header information and encoded image data from a buffer. In an exemplary embodiment, the header information is the header information generated from the first frame of image data received by the graphics controller in FIG. 8. Then, if the processor in operation 920 ends retrieval, the method ends. Otherwise, the processor alternates between the buffers to retrieve the header information and encoded image data.

It should be appreciated while the above embodiments discuss the encoding side of the image processing scheme, the invention may be extended to the decoding side also. As the image capture sensors are becoming capable of capturing more information, e.g., 3 megapixels and up, the image capture sensors may be compress the information. This allows for the information to be efficiently transferred from the image capture sensor to the graphics processor, especially in a device having limited resources.

For example, mobile communications manufacturers are developing hand-held electronic devices with camera capability in which the image capture sensors compress an image for transfer to a mobile graphics engine (MGE). One common compression format used for the compression of the image is the JPEG standard. The JPEG standard consists of a header and the actual encoded data for each block of data. Thus, a JPEG decoder of the graphics processor has to decode the header, update quantization and Huffman tables even though the values for those tables have not changed between each JPEG data unit. In order to more efficiently decode the compressed data the graphics processing chip may be programmed with the compression parameters for the quantization table and Huffman tables simultaneously with the programming of the image sensor.

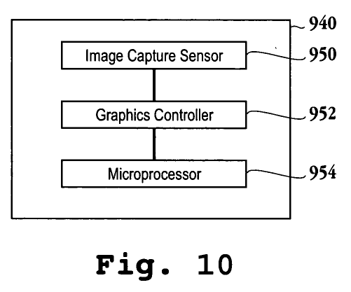

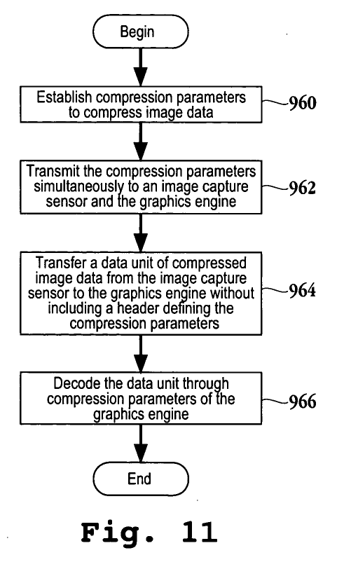

FIG. 10 is a simplified schematic diagram illustrating a portable electronic device in which an image capture sensor configured to transfer the image data to a graphics controller for decoding in accordance with one embodiment of the invention. Electronic device 940 includes image capture sensor 950 in communication with graphics controller 952, which is in communication with microprocessor 954. It should be appreciated that upon initialization image capture sensor 950 is programmed with the quantization table values and Huffman table values through graphics controller 952. That is, microprocessor 954 may initially transmit the values for the quantization table and the Huffman table to image capture sensor 950 through graphics controller 952. In one embodiment, graphics controller 952 extracts the quantization table value and loads these values into a quantization table associated with the graphics controller. Similarly, the graphics controller extracts the Huffman code values and stores these values into a Huffman table associated with the graphics controller. Therefore, as graphics controller 952 has the necessary compression parameters, i.e., quantization values and Huffman table values, there is no need for the compression data from image capture sensor 950 to include header information having the compression parameters. Thus, for all data that is sent to the graphics controller, headers are not necessary for each block of data so long as the power to device 940 is not turned off or the tables, i.e., compression parameters, are not changed.

In an alternative embodiment, rather than program the compression parameters when programming the image capture sensor 950, the compression parameters may be transferred with a first frame of image data sent by the image capture sensor to the graphics controller 952. Here, circuitry within image capture sensor 950 may be included to apply a header to a first data unit of image data sent by the image capture sensor to the graphics controller. Thereafter, the circuitry does not apply a header to subsequent blocks of data. Graphics controller 952 then extracts the compression parameters, i.e., populates the quantization tables and Huffman tables with the compression parameters from the first header, and utilizes these compression parameters to decode the compressed image data.

FIG. 11 is a flow chart diagram illustrating the method operations for enabling an electronic device to more efficiently process image data in accordance with one embodiment of the invention. The method initiates with operation 960 where compression parameters to compress image data are established. For example, with respect to JPEG compressed data, the quantization and Huffman table values are identified here. The method then advances to operation 962 where the compression parameters are simultaneously transmitted to an image capture sensor and the graphics engine. As discussed with respect to FIG. 10, the image capture sensor is programmed through the graphics controller. Therefore, the graphics controller may be configured to extract the compression parameters being used to program the image capture sensor, thereby eliminating the need for compression parameters to be sent with headers from the image capture device to the graphics controller.

The method of FIG. 11 then proceeds to operation 964 where a data unit of compressed image data is transferred from the image capture sensor to the graphics engine without including a header defining the compression parameter. As mentioned above, the extraction of the compression parameters during the programming of the image capture sensor alleviates the need to include headers on subsequent data transferred from the image capture sensor to the graphics controller. The method then moves to operation 966 where the data unit is decoded through compression parameters of the graphics engine. Here, the extracted compression parameters stored in memory of the graphics controller are used to decode the data unit. Thus, there is no need for the graphics controller to extract and reprogram the quantization and Huffman tables with each data unit received by the graphics controller. It should be appreciated that by eliminating the need to include headers with each data unit transferred from the image capture sensor to the graphics controller, more bandwidth is available for image data, the graphics controller will consume less power, and the JPEG decode times will be faster.

As an alternative to populating the tables of the graphics controller with the compression parameters when programming the image capture sensor, the data may be sent with a header applied to a first data unit of the JPEG data stream. Thereafter, the data is transmitted without headers unless the compression parameters are changed or the unit is powered off. As mentioned above with reference to FIG. 10, circuitry included within the image capture sensor may be incorporated to accomplish this embodiment.

It should be appreciated that logic of the present invention includes software or hardware embodiments. Further, embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A method of processing image data, comprising:
generating header information of a first frame of image data, the header information being stored in a first buffer at a first location and a second buffer at a corresponding second location;
encoding the frame of image data for storage in the first buffer at a third location as compressed image data; and
transmitting the stored header information and the compressed image data for decoding from the first buffer, wherein subsequent compressed image data without generating header information is stored in one of the first buffer at the third location or the second buffer at a corresponding fourth location, the transmitting including the stored header information and the subsequent compressed image data.

2. The method of claim 1, further including:
offsetting the third location from a start address of the first location and offsetting the corresponding fourth location from the start address of the corresponding second location.

3. The method of claim 1, wherein generating header information of a first frame of image data further enables eliminating generation of header information of a second frame of image data.

4. The method of claim 3, wherein eliminating generation of header information further includes disabling the generating of header information.

5. The method of claim 4, wherein disabling the generating of header information further includes disabling a signal to a codec.

6. A method of encoding image data, comprising:
receiving a first frame of image data;
generating header information of the first frame of image data;
storing both the first frame of image data as encoded image data and the header information in a first buffer; and
disabling the generation of header information, thereby storing subsequent frames of image data without generating header information.

7. The method of claim 6, further including:
transmitting both the header information and the encoded image data for the first frame of image data from the first buffer.

8. The method of claim 6, further including:
transmitting the encoded image for the subsequent frames of image data without header information from a second buffer.

9. The method of claim 6, wherein storing encoded image data further includes compressing the first frame of image data to produce the encoded image data.

10. The method of claim 8, wherein the transmitting further includes alternating storage of the encoded image data without header information between the first buffer and the second buffer.

11. A graphics controller for processing image data, comprising:
an image data encoder configured to receive and compress a first frame of image data;
a memory coupled to the image data encoder, the memory having a first buffer and a second buffer, wherein a generated header information of the first frame of image data is stored in a first portion of the first buffer and the second buffer; and
an offset portion of the first buffer and the second buffer, the offset portion of the first buffer being adjacent to the first portion of the first buffer and the offset portion of the second buffer being adjacent to the first portion of the second buffer, wherein the offset portion includes a compressed frame of image data without generated header information of a frame of image data.

12. The graphics controller of claim 11, wherein the offset portion of the first buffer is concatenated to the first portion of the first buffer.

13. The graphics controller of claim 11, wherein the offset portion of the second buffer is concatenated to the first portion of the second buffer.

14. The graphics controller of claim 11, further including:
logic capable of duplicating the generated header information in the first buffer and the second buffer.

15. The graphics controller of claim 14, wherein the logic capable of duplicating the generated header information in the first buffer and the second buffer further includes logic capable of identifying a start address of the first buffer and the second buffer.

16. The graphics controller of claim 15, wherein the logic capable of identifying the start address of the first buffer and the second buffer further includes logic capable of determining an offset address from the start address.

17. The graphics controller of claim 16, wherein the offset address identifies a beginning address of the offset portion.

18. The graphics controller of claim 1 1, wherein the image data encoder further includes an image data decoder capable of decoding image data.

19. The graphics controller of claim 1 1, further including:
transmission logic capable of transmitting the generated header information and the compressed first frame of image data.

20. The graphics controller of claim 19, wherein the transmission logic capable of transmitting the generated header information and the compressed first frame of image data further includes access logic capable of identifying one of the first buffer or the second buffer for access.

21. The graphics controller of claim 1 1, further including:
transmission logic capable of transmitting the generated header information of the first frame of image data and the compressed second frame of image data.

22. The graphics controller of claim 21, wherein the transmission logic capable of transmitting the generated header information of the first frame of image data and the compressed second frame of image data further includes access logic capable of identifying one of the first buffer or the second buffer for access.

23. A computer program embodied on a computer readable medium for processing image data, comprising:
instructions for generating header information of a first frame of image data, the header information being stored in a first buffer at a first location and a second buffer at a corresponding second location;
instructions for encoding the frame of image data for storage in the first buffer at a third location as compressed image data; and
instructions for transmitting the stored header information and the compressed image data for decoding from the first buffer, wherein subsequent compressed image data without generating header information is stored in one of the first buffer at the third location or the second buffer at a corresponding fourth location, the transmitting including the stored header information and the subsequent compressed image data.

24. The computer program of claim 23, further including:
instructions for offsetting the third location from a start address of the first location and offsetting the corresponding fourth location from the start address of the corresponding second location.

25. The computer program of claim 23, wherein instructions for generating header information of a first frame of image data further includes instructions for enabling eliminating generation of header information of a second frame of image data.

26. The computer program of claim 25, wherein instructions for enabling eliminating generation of header information further includes instructions for disabling the generating of header information.

27. The computer program of claim 26, wherein instructions for disabling the generating of header information further includes instructions for disabling a signal to a codec.

28. A method for enabling an electronic device to more efficiently process image data, comprising method operations of:
establishing compression parameters to be applied to compress the image data;
transmitting the compression parameters simultaneously to an image capture sensor and a graphics engine of the device;
transferring a data unit of compressed image data from the image capture sensor to the graphics engine without including a header defining the compression parameters; and
decoding the data unit through the compression parameters of the graphics engine.

29. The method of claim 28, wherein the method operation of transmitting the compression parameters simultaneously to an image capture sensor and a graphics engine of the device includes,
transmitting values associated with a quantization table and values associated with a Huffman table to both the image capture sensor and the graphics engine upon initialization of the device.

30. The method of claim 28, wherein the image capture sensor is a complementary metal oxide semiconductor (CMOS) sensor, the compression parameters are associated with the Joint Photographic Experts Group (JPEG) compression standard, and the first data unit is a packet of JPEG data without a header.

31. A method for efficiently process captured image data through a device, comprising method operations of:
compressing the captured image data;
applying header information to a first data unit of the compressed captured image data through logic associated with an image capture sensor;
transmitting the first data unit of the compressed captured image data to a graphics controller;
transmitting subsequent data units of the compressed captured image data to the graphics controller without any header information;
extracting compression parameters from the header information;
storing the compression parameters in memory associated with the graphics controller; and
decoding the first data unit and the subsequent data units with the compression parameters.

32. The method of claim 31, wherein the method operation of applying header information to a first data unit of the compressed captured image data through logic associated with an image capture sensor includes,
defining quantization values and Huffman values as the compression parameters.

33. The method of claim 31, wherein the method operation of compressing the captured image data includes,
converting the captured image data to a Joint Photographic Experts Group (JPEG) format.

34. An image capture device, comprising:
an image capture sensor capable of compressing captured image data; and
a graphics controller configured to program the image capture sensor with compression parameters upon initialization of the device, the graphics controller further configured to load the compression parameters into a decode module of the graphics controller thereby enabling the image capture sensor to transmit the compressed captured image data without header information.

35. The device of claim 34, wherein the decode module is a Joint Photographic Experts Group (JPEG) decoder.

36. The device of claim 34, wherein the image capture sensor is a complementary metal oxide semiconductor (CMOS) sensor and the device is a cell phone with camera capability.
